(19) United States
(12) Patent Application Publication
(10) Pub. No.: US 2026/0310007 A1
(43) Pub. Date: Oct. 8, 2026

(54) LENS ELEMENT

(71) Applicant: Essilor International, Charenton le Pont (FR)

(72) Inventor: Konogan BARANTON, Charenton-Le-Pont (FR)

(73) Assignee: Essilor International, Charenton le Pont (FR)

(21) Appl. No.: 19/481,440

(22) PCT Filed: May 22, 2024
(86) PCT No.: PCT/EP2024/064010

§ 371 Date: Nov. 4, 2025

(30) Foreign Application Priority Data
May 25, 2023 (EP) 23315218

(51) Int. Cl. G02C 7/02; G02C 7/10

(52) U.S. Cl. CPC G02C 7/022; G02C 7/10; G02C 2202/06

(57) ABSTRACT

The invention concerns a lens element intended to be worn in front of an eye of a wearer under wearing conditions comprising a substrate with a front face and a rear face, wherein the substrate comprises a set of furtive diffusive zones having a light diffusion pattern presenting a lateral diffusion pattern and minimized diffusion in a forward main direction with regard to the lateral diffusion pattern, said furtive diffusive zones are arranged in order that the forward main direction passes through the center of rotation of an eye model under wearing conditions.

### TECHNICAL FIELD

The present disclosure relates to a lens element intended to be worn in front of an eye of a person under wearing conditions in particular to suppress, reduce progression or control abnormal refractions of the eye such as myopia or hyperopia. The lens element is in particular an ophthalmic article.

The term “ophthalmic article” is specifically understood to mean a lens, corrective or otherwise, that can be used as spectacle glass, for spectacles for example, particularly sunglasses, goggles, visors or the like or a contact lens worn by the user in direct contact with his eye.

### BACKGROUND OF THE DISCLOSURE

Myopia of an eye is characterized by the fact that the eye focuses distant objects in front of its retina. Hyperopia of an eye is characterized by the fact that the eye focuses distant objects behind its retina. Myopia is usually corrected using a concave lens and hyperopia is usually corrected using a convex lens.

It has been observed that some individuals when corrected, using conventional single vision optical lenses focus inaccurately when they observe an object which is situated at a short distance away, that is to say, in near vision conditions.

This may be in particular more often the case nowadays with smart-phones that people are confronted with.

Because of this focusing defect on the part of a myopic individual which is corrected for his far vision, the image of an object close by is also formed behind his retina, even in the foveal area.

Such focusing defect may have an impact on the progression of myopia of such individuals. One may observe that for most of said individuals the myopia defect tends to increase over time.

Foveal vision corresponds to viewing conditions for which the image of an object looked at is formed by the eye in the central zone of the retina, called the foveal zone.

Peripheral vision corresponds to the perception of elements of a scene that are offset laterally relative to the object looked at, the images of said elements being formed on the peripheral portion of the retina, away from the foveal zone.

The ophthalmic correction with which an ametropic subject is provided is usually adapted for his foveal vision. However, as is known, the correction has to be reduced for the peripheral vision relative to the correction that is determined for the foveal vision. In particular, studies carried out on monkeys have shown that focusing the light far behind the peripheral retina, even with simultaneous light perfectly focused on the fovea, causes the eye to elongate and therefore causes a myopia defect to increase.

Therefore, it appears that there is a need for a lens element that would suppress, control or at least slow down progression of abnormal refractions of the eye such as myopia or hyperopia.

WO2019206569 in the name of the applicant proposes solutions by disclosing lens elements having optical elements which show in particular a focus shifting leading to a function of non-focusing an image on the peripheral retina of the eye in standard wearing conditions.

Recent controlled clinical trial provided also evidence of the benefit on slow down of myopia evolution provided by small dot arrays providing a slight diffusion in the periphery visual field.

However, it has also been observed that due to the diffusion, the visual performance of the wearer is reduced when looking into an area of the lens other than the central part.

Furthermore, such lenses with dot arrays on the top represent difficulties in traditional coating processes and therefore expose the lens to get dirty or scratched faster while it becomes more difficult to clean them.

An article entitled “In-depth optical characterization of spectacle lenses for myopia progression management” [Vol. 10, No. 5/May 2023/Optica]. In this document, the focusing and scattering properties of a single vision (SV) lens with two types of spectacle lenses for myopia progression management are compared and quantified: defocus incorporated multiple segments (DIMS), and diffusion-optical technology (DOT).

The diffuser elements are isotropic DOT or DIMS diffuser elements.

In addition, this document is based on a distance of 20 mm between the lens and the eye which is not a usual representative value.

The present disclosure aims to provide an alternative solution to achieve at least stop of progression or slow down of myopia and to overcome at least some of the above mentioned drawbacks.

### SUMMARY OF THE DISCLOSURE

In order to achieve this goal, the present disclosure proposes a lens element intended to be worn in front of an eye of a wearer under wearing conditions comprising a substrate with a front face and a rear face, wherein the substrate comprises a set of furtive diffusive zones having a light diffusion pattern presenting a lateral diffusion pattern and minimized diffusion in a forward main direction with regard to the lateral diffusion pattern, said furtive diffusive zones are arranged in order that the forward main direction passes through the center of rotation of an eye model under wearing conditions.

The lens element may present one or several of the following aspects taken alone or in combination.

The furtive diffusive zones can have an elongated shape along said main direction.

The furtive diffusive zones may be realized by holography.

According to one aspect, the furtive diffusive zones can be formed by lamellas integrated in the substrate.

The lamellas may be corrugated.

According to a further aspect, the furtive diffusive zones are for example formed by groups of particles integrated in the substrate.

The furtive diffusive zones can have a closed cross section shape, for example with polygonal or elliptic cross section.

At least one furtive diffusive zone may encircle a chromatic filter, in particular a blue or a red filter.

Furthermore, furtive diffusive zones can present a textured pattern protruding from a plane defined by the furtive diffusive zones.

The lens element may present an extinction by diffusion coefficient of maximum 40%.

According to one possible embodiment, the furtive diffusive zones are realized by laser engraving.

According to another possible embodiment, the substrate is realized by additive manufacturing and the furtive diffusive zones are for example formed by embedded particles.

In some cases, the furtive diffusive zones of elongated shape comprise for example an absorbent tail edge which is closer to the rear face of the substrate than to the front face.

The absorbent tail edge may extend in particular at least according to a transverse section of the furtive diffusive zone.

According to one embodiment, the textured pattern may comprise at least two lines of dots.

The thickness of the thin furtive diffusive zones can be less than 20 μm, in particular comprised between 5 and 15 μm and more specifically equal to 10 μm.

The thin furtive diffusive zones are for example distributed randomly within the substrate in order to avoid diffraction phenomena.

The density of the furtive diffusive zones can be chosen such that the lens element exhibits a global diffusion coefficient comprised between 1% and 3%, more specifically 2% under incoming parallel light conditions.

In some cases, the embedded particles are colored.

The invention also concerns a method for conceiving a lens element intended to be worn by a wearer under wearing condition as described above, where the orientation of the main direction of the furtive diffusive zones is determined with respect to the center of rotation of the eye of an eye model representing the wearer's eye.

### BRIEF DESCRIPTION OF THE DRAWINGS

Other advantages and features will become apparent upon reading the description of the following figures, among which:

FIG. 1 shows an example of a furtive scattering pattern,

FIG. 2 shows schematically an experimental set-up allowing to explain a simplified eye model taken into account in the present description,

FIG. 3 shows a cross sectional view of a lens element according to the present disclosure,

FIG. 4 is a perspective view of a lens element with a single diffusion zone,

FIG. 5 is a perspective view of a lens element equipped with diffusion zones according to an embodiment,

FIG. 6 shows a cross sectional view of an example of a diffusion zone formed by a lamella,

FIGS. 7A and 7B show respectively a perspective view of other examples of diffusion zones,

FIG. 8 is a perspective view of a lens element equipped with diffusion zones formed by lamellas according to FIG. 7A,

FIG. 9 shows a cross sectional view of a further example of a diffusion zone,

FIGS. 10A and 10B show respectively a top view of a diffusion zone integrating feature of FIG. 9 and a top view of a further development of a diffusion zone integrating feature of FIG. 9,

FIG. 11 is a perspective view of a lens element equipped with diffusion zones formed by lamellas according to FIG. 9,

FIG. 12 is a perspective partial view of a lens element with a single diffusion zone according to a further embodiment,

FIG. 13 shows in a graph diffusion efficiency according to different directions

FIG. 14 to 17 show different embodiments of lamellas associated with a light spreader.

### DETAILED DESCRIPTION

On all the figures, the same elements bear the same reference numbers.

The following embodiments are only examples. Although the description refers to one or several embodiments, the invention is not limited to these embodiments. In addition, a feature described in relationship with one embodiment may also concern another embodiment even if this is not mentioned expressively. Simple features of different embodiments may also be combined to provide further realizations.

In the present description, by “front” or “rear” face of a layer or a lens element or surface, reference is made to the propagation of the rays of light towards the eye through the ophthalmic lens when an ophthalmic device bearing the ophthalmic lens is worn on a wearer's face. Thus a “front” face is always that which is farthest away to the eye of the user and therefore closest to the field of view and a “rear” face is always that which is closest to the eye of the user.

The terms “upstream” or “downstream” are used in relationship with the propagation light from outside the eye, through the lens element to be worn by the wearer, his pupil towards the retina of the wearer's eye. Thus, a first thing (a surface, a layer, an image etc) is located upstream of a second thing when the light passes through its path towards the retina of the wearer first through the first thing and then through the second thing.

For example an image is located upstream or upfront the retina of the wearer's eye when the image is located in front of the retina between the pupil and the retina.

Conversely, a first thing is located “downstream” of a second thing when the light passes through its path towards the retina of the wearer first through the second element and then through the first element. Thus the retina of the wearer is located downstream of the lens element and the pupil of the wearer.

Movements of each eye of a subject can generally be considered as being a combination of rotations about a particular locus/location that is referred to as the center of rotation of the eye or “eye rotation center”, hereinafter also referred to as ERC. The locus is obtained as the set of all instantaneous rotation centers for different gaze directions. From the biological point of view, the ERC can be considered more a «small volume enclosing all instantaneous rotation centers and not one geometrical rotation point.

The present description refers to an ERC of an eye model.

For a wearer, the ERC can for example be determined approximately from the position of the cornea by assuming a mean value for the radius of the eye, typically a value of about 15 millimeters (mm).

Other known methods may be based on image processing, wherein one captures, by means of an image capture apparatus, at least two facial images of the subject equipped with a reference accessory while the subject looks at this image capture apparatus.

These images are treated in order to determine the ERC. The reference accessory gives information on the relative position of the head of the subject and the image capture device.

EP3420887 in the name of the applicant also discloses a method for determining the eye rotation center (ERC) of a wearer.

In particular this document which is included by reference discloses a method for determining a position of the eye rotation center (ERC) of an eye of a wearer comprising:
providing a geometric model of an eye, whereby the position of the eye rotation center (ERC) of this eye is determined based on a set of personal parameters including at least a first geometric dimension of the eye, each personal parameter being distinct from said position of the eye rotation center of the eye (ERC);
determining a value of each personal parameter for the subject; and
determining a first approximate value of said position of the eye rotation center of the eye of the wearer in accordance with said geometric model based on the values of the personal parameters.

By “geometric model” of the eye, one understands any physical model adapted to summarize both the optical path of the light through a human eye, and also the movements of this eye.

As the physiological structure of a human eye is very complicated, a complete and exhaustive geometric model of an eye is very hard to elaborate, taking into account all the optical surfaces and physical media involved in the optical path of the light through the eye. But for the sake of the present disclosure, it is not necessary to take into account all these parameters.

Advantageously, a simple geometric model may be used wherein the geometry of the eye is partially modeled for example with only two spheres nested one in the other (see Lefohn A. et al., “An ocularist's approach to human iris synthesis”, IEEE Computer Graphics and Applications, Vol. 23, Issue 6, November-December 2003). A first part of one sphere can be contemplated as the sclera of the eye: the eye rotation center is positioned at the center of this sphere. A second part of the other sphere can be contemplated as the cornea of the eye.

Other models of an eye are for example described by David A Atchison in «Vision Research, Volume 46, Issue 14, July 2006, Pages 2236-2250».

In the present disclosure, it is referred to a simplified geometric eye model which allows testing and measurements on an experimental testing bench.

As will be explained later in detail, the description refers to diffusive zones which are qualified as «furtive». These furtive diffusive zones are characterized by a specific light diffusion pattern with an enhanced lateral diffusion pattern and minimized diffusion in a forward main direction with regard to the lateral diffusion pattern. The forward main direction is defined by the direction of light beam/light ray pointing toward the ERC. The lateral diffusion pattern may be for example in form of side lobes or in form of a hollow cone pattern (with a ring-shaped impact area). The specificity of such furtive diffusion zones is that diffusion is minimized in forward main direction, in particular in a cone having an angular aperture of at least 5°, in particular at least 10° or even 20°. Thus in forward direction and inside this cone, no or very few light rays originating from a scattering/diffusion phenomena are present. In other diffusion patterns, like isotropic or cosine diffusion, this is not the case and light diffusion in forward direction is important.

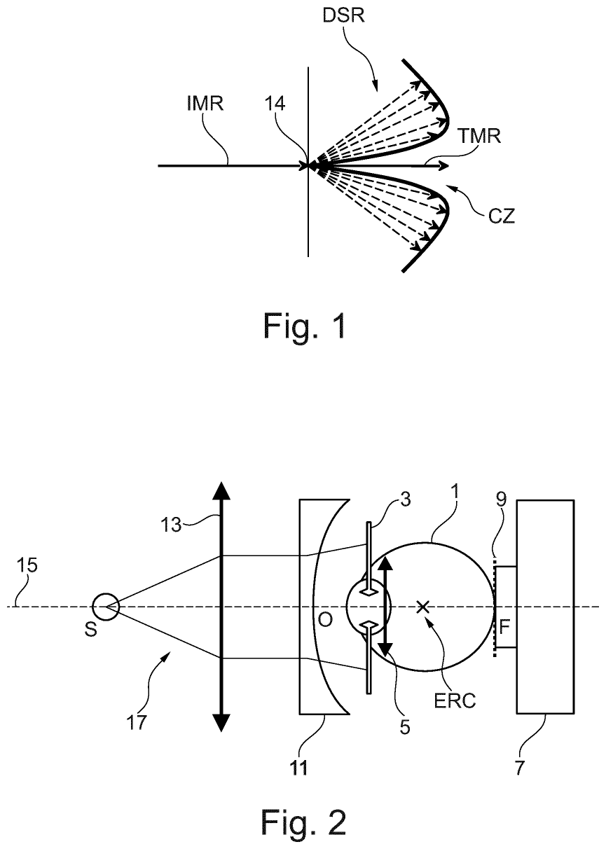

An example of a furtive scattering pattern is shown in FIG. 1.

In this Figure IMR designates an incident light main ray. One furtive diffusive zone 14 is represented schematically as a dot. TMR designates the transmitted main ray with an intensity which is lower than the incoming light ray intensity in particular because of diffusion, but also reflexion for example at surface boundaries. Diffused secondary rays DSR are represented as hashed arrows and show directions in which light rays are diffused. As can be seen in FIG. 1, there exists an essentially conic zone CZ around the transmitted main ray TMR, where no or very few diffused light rays are present. Mainly the diffused secondary rays DSR are located at an angular range with regard to the transmitted main ray TMR comprised between 5⁰ or 10° and less than 45°. As will be explained beneath, this specific diffusion pattern can be used in ophthalmic lens elements for controlling myopia while only degrading little or not at all vision performance by arranging the furtive diffusive zones 14 in a particular way with regard to the eye rotation center ERC.

FIG. 2 shows an experimental testing bench which shows the contour of an eye 1 and the eye rotation center ERC which can be considered as a simplified geometric eye model allowing testing and measurements. The eye's pupil with a diameter comprised typically between 0.5 and 8 mm is represented by a corresponding diaphragm 3. The eye's lens is represented by a lens 5 with a focal length of for example F′=−16 mm and disposed downstream the diaphragm 3. The eye's retina is represented by a camera 7 having an image sensor 9 which represents the retina of a wearer. The image sensor 9 is disposed such that the focus point F of the lens 5 is on the image sensor 9. Thus, the geometric simplified eye model taken into account for the present disclosure comprises as parameters at least the position of the eye's rotation center ERC, the focal length of lens 5 and the diameter of the diaphragm 3 or equivalent parameters.

Furthermore, a lens element 11 to be tested is disposed upstream the diaphragm 3 at a wearing condition distance of 12 mm upstream the diaphragm.

Moreover, a light source S and a collimator lens 13 are disposed on the center axis 15 upstream the lens element 11 in order to provide an illumination with parallel/collimated light rays 17 which are represented schematically in FIG. 1. The light source S may be offset from the center axis 15 and arranged in a way that a zone on the image sensor 9 which would correspond to the foveal zone of the retina of the wearer is only partially directly illuminated by transmitted main rays TMR, meaning for example at most 50%.

Humans retina and eyes have been extensively analysed (see for example https://en.wikipedia.org/wiki/Foveola) such specific zones, in particular foveal zone and peripheric zones (like parafovea, perifovea and macula) of the retina are well known in size and location and thus on an image sensor it is quite easy to identify corresponding zones.

The disclosure relates to a lens element 11 intended to be worn in front of an eye of a wearer under wearing conditions.

In the context of the present disclosure, the term “lens element” refers to a lens blank, an uncut optical lens, a spectacle optical lens edged to fit a specific spectacle frame or an ophthalmic lens.

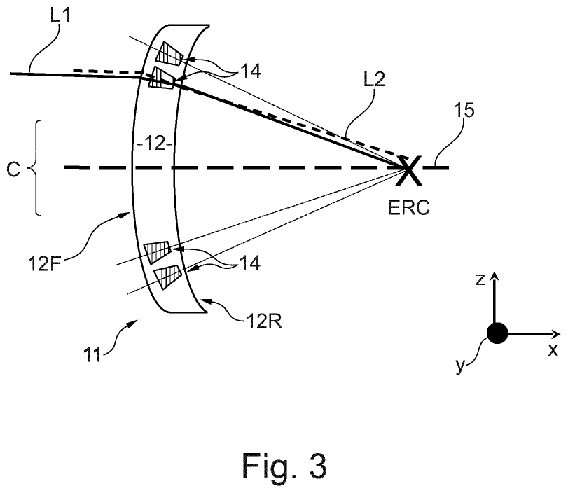

FIG. 3 shows a simplified cross sectional view of an example of a lens element 11 intended to be worn in front of an eye of a wearer under wearing conditions according to the disclosure.

The lens element 11 comprises a substrate 12 with a front face 12F and a rear face 12R.

The front face 12F and the rear face 12R have respectively a refractive power based on a prescription of an eye of a wearer.

The aim of the refractive power of the front face 12F and rear face 12R based on a prescription of an eye of the wearer is to form a sharp or at least sharper image (in comparison without lens element 11) on the retina of the wearer. Parallel incoming light beams would be focused on the retina and this would be the case for foveal and peripheral zones of the retina.

A hard coat layer may protect the lens element 11 and cover the front face 12F and/or the rear face 12R.

The substrate 12 of the lens element 11 is for example made of a plastic material, for instance a polymer substrate like a thermoset, in particular made of poly(urea-urethane), or thermoplastic plastic material, in particular made of polyamide (PA), like nylon or a polycarbonate, or polyester.

According to one embodiment, the lens element 11 is manufactured by additive manufacturing, for example a 3D printing process. Therefore as material for lens element 11, a plastic material with optical transmission properties comparable to those of materials generally used for lens manufacturing and which is suitable for 3D printing is preferred.

As shown in FIG. 3, the substrate 12 includes furtive diffusive zones 14 having for example an elongated shape. In FIG. 3, a right handed Cartesian coordinate system x,y,z is represented and the thickness of the furtive diffusive zones 14 extends in FIG. 3 in y-direction which is perpendicular to the plane of the drawing sheet.

The furtive diffusion zones 14 are quite thin. In the present context, ((thin means that the furtive diffusive zones 14 have a thickness which is less than 20 μm, in particular comprised between 5 and 15 μm and more specifically between equal to 10 μm+/−1 μm.

In particular the furtive diffusive zones 14 of elongated shape may be formed as shown in FIG. 3 by lamellas which are integrated or embedded in the substrate 12. The lamellas 14 may be formed like a plane and oriented such that the eye rotation center ERC is included in its geometric plan imaged by the rear face of the lens 12R when considered extended to the ERC.

Such diffusive lamellas 14 can be realized by laser engraving.

In the embodiment of FIG. 3, the diffusive lamellas 14 can be considered as small embedded plates and their orientation is selected in order that under incoming collimated light conditions (as shown in FIG. 3), the diffusion efficiency of the thin furtive diffusive zones 14 for light rays downstream the lens element 11 and passing through the center of rotation ERC of the eye model under wearing conditions is lower with respect to light rays downstream the lens element and not passing through the center of rotation ERC of the eye model under wearing conditions.

As explained above, the lamellas 14 form furtive diffusive zones having a light diffusion pattern presenting a lateral diffusion pattern and minimized diffusion in a forward main direction with regard to the lateral diffusion pattern.

The lamellas as furtive diffusive zones 14 are arranged in order that the forward main direction (which corresponds also to the direction of the transmitted main ray TMR) passes through the center of rotation ERC of an eye model under wearing conditions.

In other words, light rays downstream the lens element 11 and passing through the center of rotation ERC of the eye model are rays corresponding mainly to transmitted main rays TMR which have not been scattered or diffused by the furtive diffusive zones 14 whereas light rays downstream the lens element 11 and not passing through the center of rotation ERC correspond mainly to diffused secondary rays DSR.

One reason to that is that due to the orientation of the furtive diffusive zones 14, here the lamellas, light rays impinging the diffusive lamellas are scattered in many directions except for or less than in the direction that would let a light ray go through the center of rotation once refracted by rear face 12R of the simplified eye model and reach the retina.

This allows that diffusion is minimized in the foveal zone of the retina of the wearer and lower than in a peripheral zone of the retina of the wearer. In other words, diffusion is enhanced in a peripheral zone of the retina and lower in the foveal zone.

According to this achievement, a slow down of myopia evolution is provided by diffusion in the periphery visual field while achieving a better visual performance of the wearer in the foveal region of the retina.

More specifically, under incoming collimated light conditions, the furtive diffusive zones 14 are oriented such that the diffusion efficiency of the thin furtive diffusive zones (lamellas in FIG. 2) for light rays downstream the lens element 11 (meaning after passing/being refracted the rear face 12R of the substrate 12) and passing through the center of rotation ERC of the eye model under wearing conditions is at most 50% of the diffusion efficiency of the thin furtive diffusive zones 14 for light rays downstream the lens element 11 and originating from the same point and turning away by an angle greater than 2° to those light rays passing through the center of rotation ERC of the eye model under wearing conditions.

In FIG. 3 is shown a light-ray L1 which is parallel to the optical axis of the lens element 11 upstream the lens element 11 and which passes through the eye rotation center ERC after passing the lens element 11. Light-ray L1 corresponds for the path downstream lens element 11 to a transmitted main ray TMR.

In FIG. 3 is also shown a light-ray L2 which is parallel to the optical axis 15 of the lens element 11 upstream the lens element 11. L2 originating from the same point at the rear face 12F of the substrate 12 but turning away by an angle greater than 2° compared to L1 passing through the eye center of rotation ERC. Thus L2 does not pass through the eye rotation center ERC. Light-ray L2 corresponds for the path downstream lens element 11 to a diffused secondary ray DSR.

Thus, as already stated above, this allows that diffusion is enhanced for peripheral zones of the retina while on the foveal zone, diffusion is less present and does not or at least at a low level disturb the vision performance of the wearer.

In the experimental set-up of FIG. 2, these features can be demonstrated by using a mask element (like an opaque adhesive sticker) with a hole which allows to isolate a diffusion zone and specific scattering interaction of a diffusion zone 14 with incoming collimated light-rays.

The lens element 11 to be tested is placed in the experimental set-up of FIG. 1 with respect to the ERC corresponding to the relative positioning of the lens element 11 and determined ERC of a wearer who shall be equipped with the lens element 11.

In the specific embodiment of FIG. 3, the lens element 11 presents a central area C which is for example free of furtive diffusive zones 14, but this is not necessarily the case for all embodiments.

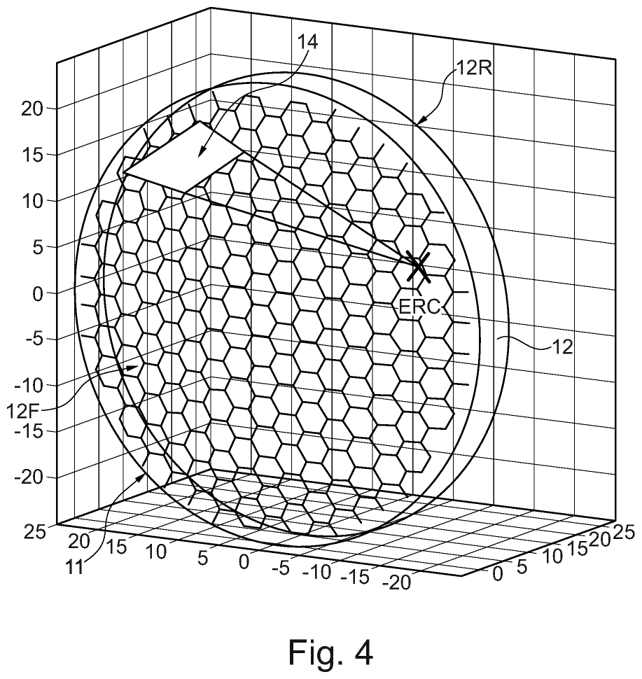

FIG. 4 shows for sake of explanation a perspective schematic view of a lens element 11 with an exemplary single furtive diffusion zone 14 of elongated shape (lamella) embedded into the substrate 12.

According to the embodiment of FIG. 4, the furtive diffusive zone 14 of elongated shape comprises an absorbent tail edge 14R which is closer to the rear face 12R of the substrate than to the front face 12F.

The absorbent tail edge 14R further reduces the amount of diffused light of the furtive diffusive zones in forward main direction that may reach the foveal zone.

As shown in FIG. 4, the absorbent tail edge 14R extends at least according to a transverse section of the furtive diffusive zone, specifically perpendicular to a direction passing through the eye rotation center ERC after refraction by rear face 12R.

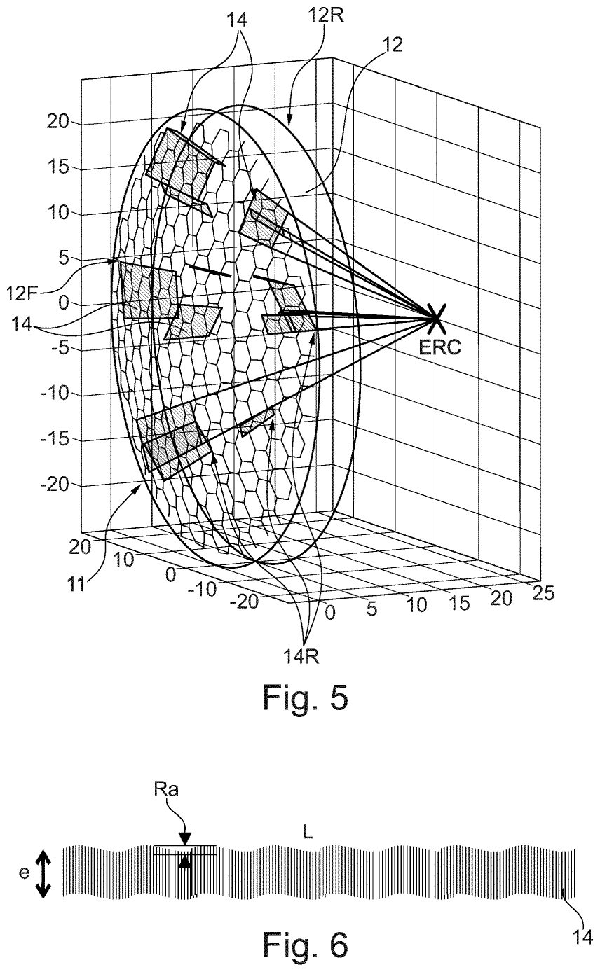

FIG. 5 is a similar view in perspective to that of FIG. 4 with the difference that a certain number of furtive diffusive zones 14 of elongated shape are shown. All shown furtive diffusive zones 14 are lamellas having an absorbent tail edge 14R extending at least according to a transverse section of the furtive diffusive zone 14 it belongs to.

The light which enters through the pupil and reaches the fovea passes through the eye center ERC and is aligned with the furtive diffusive zones 14 and then is not or only very slightly diffused. From the wearer's retina, the scattering of the furtive diffusive zones 14 is almost invisible/perceptible in his/her central vision. The light which enters through the pupil and reaches the perifovea is not be aligned with furtive diffusive zones 14 and is more scattered. This permits to maintain the myopia control effect.

As stated above, the visibility of the scattered light from the wearer's retina is further reduced by adding the adsorbant tail edges 14R preventing thus scattered light from propagating toward the fovea.

The furtive diffusive zones 14 may be obtained in several ways.

As stated above, the furtive diffusive zones 14 may be obtained by laser engraving.

In this case for example, the substrate material is locally melted or altered in a way that light impacting the engraved zone is diffused.

Another possibility to form the furtive diffusive zones 14 of elongated shape comprises additive manufacturing and for example the diffusive lamellas 14 are realized by a plastic material which is compatible with the substrate material, but having for example a different index of refraction (at least a difference of 0.1) or by having a gradient of index of refraction, like a inhomogeneous or «tubulence-like» distribution of index of refraction.

The lamellas 14 may be corrugated as shown in FIG. 6 showing a cross section of a single lamella 14.

With respect to this, the lamellas 14 may present a thickness e of about 0.1 mm, a length or extension L of about 1 mm and a certain surface roughness Ra, which may be 1/10 of the thickness.

The lamellas 14 may also be fluorescent, meaning exhibit fluorescent properties which allows to elevate the retinal illumination. In order to reduce risk of dazzling the wearer, the edges of the lamellas 14 may be slit. Fluorescent lamellas 14 may be obtained by additive manufacturing and in using a fluorescent plastic material which is compatible with the substrate material. The fluorescing color of these lamellas may be yellow or red for example.

In other embodiments, the furtive diffusive zones 14 of elongated shape are formed by groups of particles integrated in the substrate.

Furthermore, in case of additive manufacturing of the lens element, the furtive diffusive zones 14 can be formed by diffusive ink or diffusive powder.

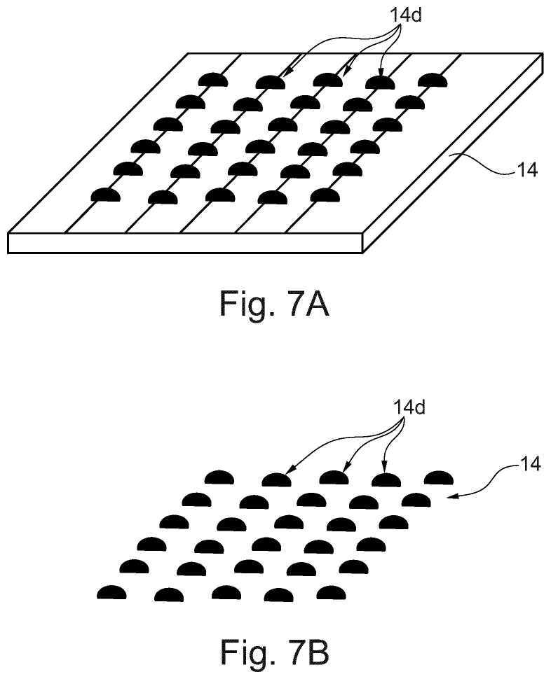

In FIG. 7A is shown another example where the furtive diffusive zone 14 present a textured pattern, for example lines of dots 14d protruding from a plane defined by the thin diffusive zones 14.

In FIG. 7B is shown a further example where the furtive diffusive zone 14 present a textured pattern, for example lines of dots 14d protruding from a geometrical, but not physical plane. In this case, the set of lines of dots 14d form together a furtive diffusive zone 14.

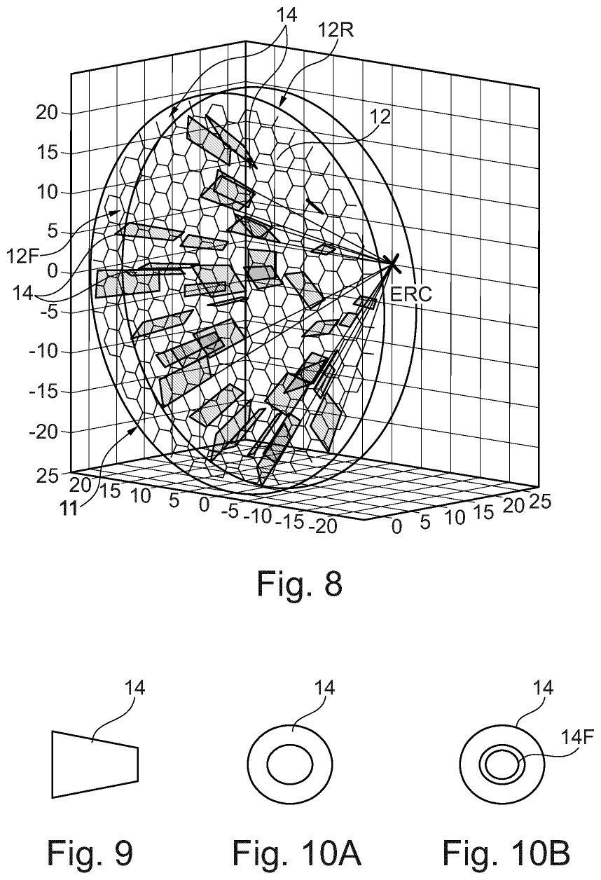

FIG. 8 is a similar perspective view to that of FIG. 5 with furtive diffusive zones 14 formed by lines of dots 14d as shown in FIG. 7A.

According to another embodiment, the furtive diffusive zones 14 have a closed cross section shape, for example with polygonal or elliptic cross section.

FIG. 9 shows a cross section view of a furtive diffusive zone 14 having a frustoconical shape.

FIG. 10A shows the furtive diffusive zone 14 having a frustoconical shape in a «top view» from the front face 12F in refracted direction to the eye rotation center ERC.

FIG. 10B is a further development and shows the same view as FIG. 10A. According to this specific embodiment, at least one furtive diffusive zone 14 encircles a chromatic filter, in particular a blue or a red filter 14F.

Using different chromatic filters allows to change the spectrum of light which reaches the fovea or the peripheral retina, regardless of whether it is transmitted, absorbed and scattered.

For instance, a disk shape filtering stopper 14F as in FIG. 9 could be added in the middle of each tube, with different spectral transmission properties from cylinder sides which form the furtive diffusive zones 14.

It is also possible with any shape of surfaces (even different from the tube shape) approximately orthogonal to the tube, i.e. whose normal passes through the eye's center of rotation.

A specific application can be achieved in order to reduce the peripheral hyperopic defocus, known as being a source of myopia. The peripheral defocus is caused by lower curvature of the image surface (usually misnamed image “plan” see https://en.wikipedia.org/wiki/Petzval_field_curvature for this no flat image surface) than the curvature of the retina. The solution proposed here consists in designing blue cylinders as furtive diffusive zones 14 with red filtering stoppers 14F.

On one hand, this shifts the image toward the red in the foveal, and toward the blue in the peripheral retina. On the other hand, the eye longitudinal chromatic aberration makes the red focus longer than the blue one. These two effects shift back the foveal red image and shift in front the peripheral blue image; the curvature of the image surface is increased and the peripheral defocus is then reduced.

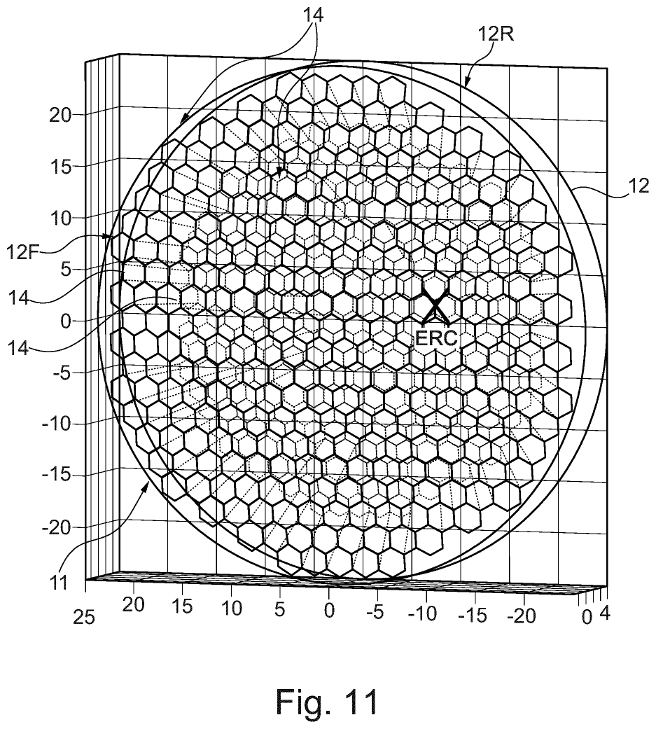

FIG. 11 is a similar perspective view to that of FIG. 5 with furtive diffusive zones 14 formed by frustoconical shaped tubes with hexagonal cross section, as a curved/conic honeycomb.

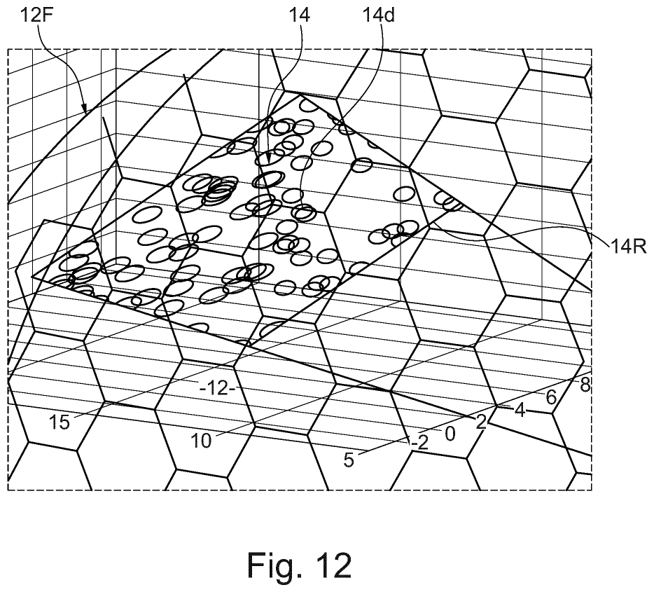

FIG. 12 shows another example of a furtive diffusive zone 14 with an adsorbant tail edge 14R. In this case the furtive diffusive zone 14 comprises randomly distributed dots 14d of various sizes within the substrate in order to reduce diffraction phenomena induced by regular/periodic pattern.

According to a non-represented example the furtive diffusive zones 14 are distributed randomly within the substrate 12 in order to avoid diffraction phenomena.

According to a further embodiment, the furtive diffusive zones 14 may be realized by holography. In this case the set of furtive diffusive zones 14 may be reduced to one single diffusive zone 14.

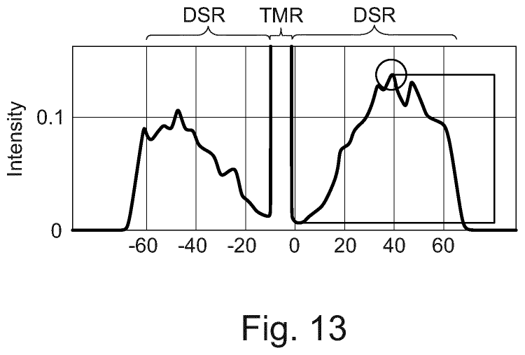

FIG. 13 shows an example of a result which has been obtained with a lens element 11 having very few furtive diffusive corrugated zones 14 as shown in FIG. 6 for illustrative purpose and where accordingly the furtive diffusive corrugated zones 14 present a thickness e of 0.1 mm, a scattering coefficient of 20% and an absorbance coefficient of 20%.

In this graphics, 0°+/−2.5° represents the foveal region of the retina and 20 to 60°, or −60° to −20° peripheral regions of the retina.

For establishment of this graph, the illumination by the incoming collimated light is such that the foveal zone (for the experimental setup the region of the image sensor 9 corresponding to the foveal zone) is at most partially illuminated, at most in particular for 50%.

The transmitted main rays TMR can be seen in the graph between −10° and 0°. The scale for intensity was chosen to allow to show the evolution of the diffused secondary rays DSR. Thus the intensity of the TMR is out of the chosen scale.

The graph shows the diffusion efficiency and as one can see, diffusion/intensity of DSR is lower/minimized for the foveal region of the retina.

It allows to demonstrate the furtive diffusive zones 14 allow to minimize DSR to reach the foveal zone of the eye and that the intensity of the diffusive secondary rays DSR increases from the foveal region on either side of the zone of TMR to the peripheral region until reaching a maximum, in this example around −45° and 40°.

The density of the furtive diffusive zones 14 is for example chosen such that the lens element 11 as a whole exhibits a global diffusion efficiency comprised between 10% and 20%, more specifically 15% under incoming parallel light conditions.

This can be measured by determination of transmission Haze, which is the amount of incoming light which is subject to wide angle scattering (at an angle greater than 2.5° from normal, according to norm specification ASTM D1003). Indeed ASTM ASTM D1003 Standard is relative to a test method for Haze and Luminous Transmittance of Transparent Plastics

The lens element 11 presents an extinction by diffusion coefficient of maximum 40%.

This allows efficient myopia control without giving a «milky aspect» to the lens element 11.

The extinction by diffusion can be determined by measuring the luminous transmittance T_{V} and luminous reflectance R_{V} of lens element 11.

For reminder, the luminous transmittance in ISO standard 13666 is defined as:

$${τ}_{v} = 100 \times \frac{{{\int }_{380 nm}}^{780 nm} τ ( λ ) \cdot V ( λ ) \cdot SD 65 λ ( λ ) \cdot d λ}{{{\int }_{380 nm}}^{780 nm} V ( λ ) \cdot SD 65 λ ( λ ) \cdot d λ} \%$$

where
τ(λ) is the spectral transmittance of the tinted spectacle lens;
V(λ) is the spectral luminous efficiency function for daylight (see ISO/CIE 10527);
S_{D65λ}(λ) is the spectral distribution of radiation of CIE standard illuminant D65 (see ISO/CIE 10526).

Reflectance is defined to be the average luminous reflectance R_{V} in the visible domain such as defined in standard ISO 12311:2013 section 7.7:

The value of R_{V} in percent is obtained by calculating the ratio of the light flux reflected by the front face of the masking medium 15 Φ_{R} to the incident flux Φ_{I} as follows:

$${R}_{V} = 100 \times \frac{{Φ}_{R}}{{Φ}_{I}} = 100 \times \frac{{\int }_{380}^{780} ρ ( λ ) \cdot V ( λ ) \cdot {S}_{D 65} ( λ ) \cdot d}{{\int }_{380}^{780} V ( λ ) \cdot {S}_{D 65} ( λ ) \cdot d}$$

where:
   λ—is wavelength in nanometres;
   ρ(λ)—is the spectral reflectance of the front face of the masking element 15 at the wavelength λ;
   V(λ) is the relative sensitivity of the human eye, such as defined in ISO 11664-1;
   S_{D65}(λ) is the spectral power distribution of CIE standard illuminant D65, such as defined in ISO 11664-2.

The extinction by diffusion is the difference of 100%−(T_{V}+R_{V}), or on other words, the part of the luminous incident energy with is neither transmitted, nor reflected by lens element 11.

In order to verify for example the global diffusion efficiency, one might use the experimental set-up described in FIG. 2 and in particular measure these parameters in making a first measurement with a lens element 11 comprising the diffusive zones 14, a second measurement with a lens element 11 which is the same as the lens element for the first measurement except that it does not comprise the furtive diffusive zones 14, and compare both measurements, in particular by subtracting first measurement from the second measurement which gives therefore the diffusion contribution of the furtive diffusive zones 14.

The set-up in FIG. 2 can also be used to measure and quantify the amount of diffused light reaching the foveal or peripheral regions of the retina.

One possible measurement would be to illuminate the lens element 11 with a collimated light beam and to measure diffusion by turning diaphragm 3, lens 5 and the camera 7 with the image sensor 9 around the eye rotation center by angular steps.

This allows to show that the diffusion efficiency of the lens element 11 resulting from the thin furtive diffusive zones 14 for light rays downstream the lens element 11 and passing through the center of rotation ERC of an eye model under wearing conditions is lower with respect to light rays downstream the lens element and not passing through the center of rotation ERC of the eye model under wearing conditions and to quantify the diffusion.

Reference is now made back to FIGS. 4 and 5 where the furtive diffusive zone 14 of elongated shape comprises an absorbent tail edge 14R which is closer to the rear face 12R of the substrate than to the front face 12F.

As stated above, the absorbent tail edge 14R further reduces the amount of diffused light of the furtive diffusive zones in forward main direction FMD that may reach the foveal zone.

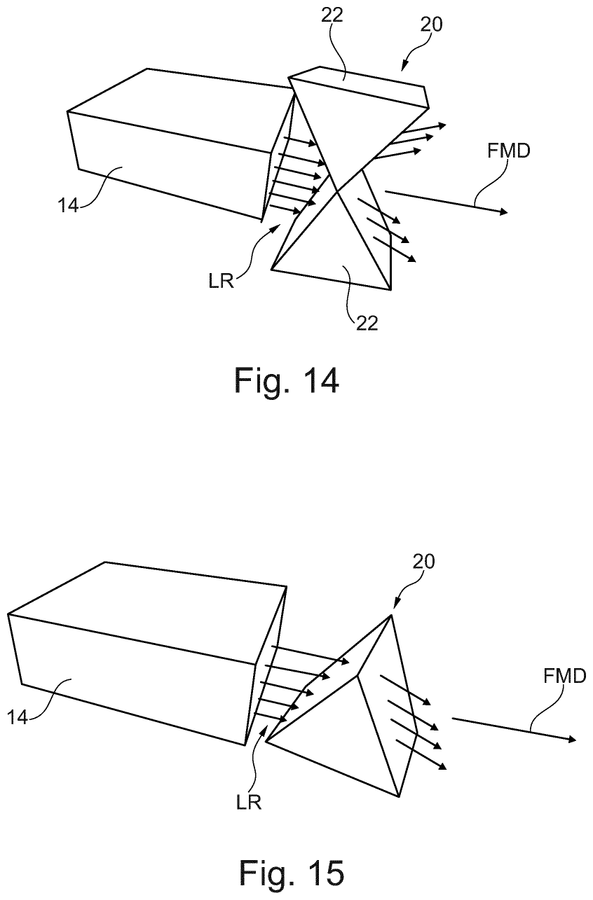

According to further embodiments shown in FIGS. 14-17, the idea for reducing the amount of diffused light of the furtive diffusive zones in the forward main direction is instead of absorption, to spread away light rays LR which are parallel to the forward main direction FMD at the output of the furtive diffusion zone 14 of elongated shape and that would pass through the ERC and reach the foveal zone.

In order to do so, the substrate 12 further comprises for at least one furtive diffusion zone 14 of elongated shape an associated light spreader 20. Such a light spreader 20 should be located downstream the tail edge of the furtive diffusion zone 14 of elongated shape and on the path of the forward main direction FMD in order to deviate light rays which are parallel to the forward main direction FMD at the output of the furtive diffusion zone of elongated shape out of the forward main direction FMD, meaning deviating them at least by a small angle.

This is shown in FIG. 14 where the light spreader 20 exhibits a general shape of an hour glass with two prisms 22, for example of equilateral shape which face each other with their respective tips.

In FIG. 15, the light spreader 20 is a simple for example equilateral prism 24 to just deviate the light beams by a random angle, in a random direction to spread scattered light equally on the retina.

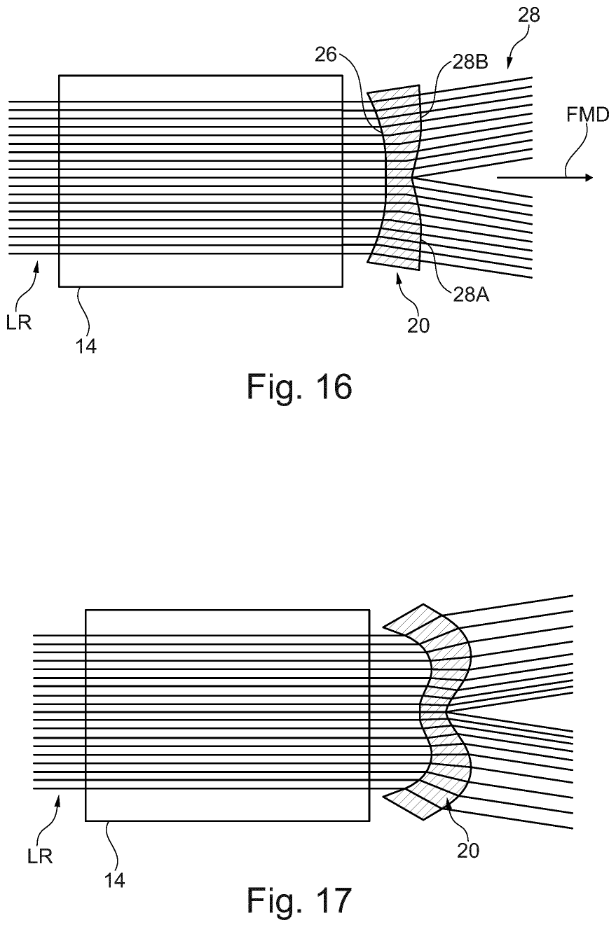

Other more complex shapes like shown in FIG. 16 or 17 may be considered. In FIG. 16, the light spreader 20 has a first face 26 near the output of the lamella 14 which is of concave shape and a second face 28 with two convex diopters 28A and 28B like a general squeezed convex shape.

In FIG. 17, the light spreader 20 has a double “S” shape and a thickness which changes in a direction which is sensible perpendicular to the forward main direction.

From the above, one clearly understands that a lens element 11 as described above allows efficient myopia control while not disturbing the vision performance of the wearer.

1. A lens element intended to be worn in front of an eye of a wearer under wearing conditions comprising:
a substrate with a front face and a rear face,
wherein the substrate includes a set of furtive diffusive zones having a light diffusion pattern presenting a lateral diffusion pattern and minimized diffusion in a forward main direction with regard to the lateral diffusion pattern, said furtive diffusive zones are arranged in order that the forward main direction passes through the center of rotation of an eye model under wearing conditions.

2. The lens element according to claim 1, wherein the furtive diffusive zones have an elongated shape along said main direction.

3. The lens element according to claim 1, wherein the furtive diffusive zones is/are realized by holography.

4. The lens element according to claim 1, wherein the furtive diffusive zones are formed by lamellas integrated in the substrate.

5. The lens element according to claim 4, wherein the lamellas are corrugated.

6. The lens element according to claim 4, wherein the lamellas are fluorescent.

7. The lens element according to claim 1, wherein the furtive diffusive zones of are formed by groups of particles integrated in the substrate.

8. The lens element according to claim 1, wherein the furtive diffusive zones have a closed cross section shape.

9. The lens element according to claim 8, wherein at least one furtive diffusive zone encircles a chromatic filter, includes a blue or a red filter.

10. The lens element according to any of claim 3, wherein furtive diffusive zones present a textured pattern protruding from a plane defined by the furtive diffusive zones.

11. The lens element according to claim 1, where the lens element presents an extinction by diffusion coefficient of maximum 40%.

12. The lens element according to claim 1, where the furtive diffusive zones are realized by laser engraving.

13. The lens element according to claim 1, wherein the substrate is realized by additive manufacturing and wherein the furtive diffusive zones are formed by embedded particles.

14. The lens element according to claim 3, wherein the furtive diffusive zones of elongated shape include an absorbent tail edge which is closer to the rear face of the substrate than to the front face.

15. The lens element according to claim 14, wherein the absorbent tail edge extends at least according to a transverse section of the furtive diffusive zone.

16. The lens element according claim 3, wherein the substrate further includes, for at least one furtive diffusion zone of elongated shape, an associated light spreader located downstream a tail edge of the furtive diffusion zone of elongated shape on a path of the forward main direction in order to deviate light rays which are parallel to the forward main direction at an output of the furtive diffusion zone of elongated shape out of the forward main direction.

17. A method for conceiving a lens element intended to be worn in front of an eye of a wearer under wearing conditions comprising:
a substrate with a front face and a rear face,
wherein the substrate of the lens element includes a set of furtive diffusive zones having a light diffusion pattern presenting a lateral diffusion pattern and minimized diffusion in a forward main direction with regard to the lateral diffusion pattern, said furtive diffusive zones being arranged in order that the forward main direction passes through the center of rotation of an eye model under wearing conditions, and
wherein an orientation of the main direction of the furtive diffusive zones is determined with respect to the center of rotation of the eye of an eye model representing the wearer's eye.

18. The lens element according to claim 2, wherein the furtive diffusive zones is/are realized by holography.

19. The lens element according to claim 5, wherein the lamellas are fluorescent.

20. The lens element according to claim 1, wherein the furtive diffusive zones have a closed cross section shape including with polygonal or elliptic cross section.
